(19) United States
(12) Patent Application Publication
(10) Pub. No.: US 2016/0274042 A1
(43) Pub. Date: Sep. 22, 2016

(54) NON-HOMOGENEOUS SAMPLE SCANNING APPARATUS, AND X-RAY ANALYZER APPLICATIONS THEREOF

(71) Applicant: X-RAY OPTICAL SYSTEMS, INC., East Greenbush, NY (US)

(72) Inventors: Zewu CHEN, Schenectady, NY (US); George ALLEN, Middle Grove, NY (US); Peng LU, Menands, NY (US); Joseph SPINAZOLA, Medway, MA (US)

(73) Assignee: X-RAY OPTICAL SYSTEMS, INC., East Greenbush, NY (US)

(21) Appl. No.: 15/036,131

(22) PCT Filed: Nov. 11, 2014
(86) PCT No.: PCT/US2014/064927

§ 371 Date: May 12, 2016

Related U.S. Application Data
(60) Provisional application No. 61/902,901, filed on Nov. 12, 2013.

(51) Int. Cl. G01N 23/223

(52) U.S. Cl. CPC G01N 23/223

(57) ABSTRACT

A sample scanning apparatus/technique/method for a material analyzer, including moving a sample cell containing a sample over a measurement focal area of the analyzer according to a scan pattern, thereby scanning the sample over the measurement focal area in the scan pattern, and exposing multiple areas of the sample to the focal area. A sample cell rotator for rotating a sample cell is provided; along with a linear motion stage. The combined rotation and linear movement results in scanning the sample over the focal area in a scan pattern, thereby exposing multiple areas of the sample to the focal area. The sample scanning apparatus may be used in combination with an optic-enabled x-ray analyzer, the x-ray analyzer including an x-ray engine with an x-ray excitation path and an x-ray detection path, wherein the x-ray excitation and/or the x-ray detection path define the sample focal area.

### CROSS-REFERENCE TO RELATED APPLICATION

This application claims the benefit of U.S. provisional patent application Ser. No. 61/902,901, filed Nov. 12, 2013, which is hereby incorporated herein by reference in its entirety.

### TECHNICAL FIELD

This invention relates in general to apparatuses and methods used for analysis of samples. More particularly, the present invention is directed to non-homogeneous sample scanning in, e.g., an x-ray analysis system.

### BACKGROUND OF THE INVENTION

X-ray analysis of samples is a growing area of interest across many industries such as consumer products, medical, pharmaceutical, environmental, and petroleum. The use of x-ray fluorescence, x-ray diffraction, x-ray spectroscopy, x-ray imaging, and other x-ray analysis techniques has led to a profound increase in knowledge in virtually all scientific fields.

X-ray fluorescence (XRF) is an analytical technique by which a substance is exposed to a beam of x-rays to determine, for example, the presence of certain components. In XRF, at least some of the elemental constituents of the substance exposed to x-rays can absorb x-ray photons and produce characteristic secondary fluorescence. These secondary x-rays are characteristic of the elemental constituents in the substance. Upon appropriate detection and analysis these secondary x-rays can be used to characterize one or more of the elemental constituents. XRF techniques have broad applications in many chemical and material science fields, including water, environmental, industrial, medical, semiconductor chip evaluation, petroleum, and forensics, among others.

U.S. Pat. Nos. 6,934,359 and 7,072,439, hereby incorporated by reference herein in their entirety, and assigned to X-Ray Optical Systems, Inc., the assignee of the present invention, disclose monochromatic wavelength dispersive x-ray fluorescence (MWD XRF) techniques and systems for the analysis of liquid samples, e.g., for trace level measurement of sulfur in petroleum products. U.S. Pat. No. 7,738,630, hereby incorporated by reference herein in its entirety, and assigned to X-Ray Optical Systems, Inc., the assignee of the present invention, discloses monochromatic excitation, energy dispersive x-ray fluorescence (ME-EDXRF) techniques and systems for, e.g., for trace level measurement of toxins in a variety of substances including water, petroleum products, and consumer products.

XRF testing can take place off-line, i.e., using a bench-top, laboratory-type instrument to analyze a sample. The material is removed from its source (e.g., for fuel, from a refinery or transportation pipeline) and then deposited in a sample chamber; or into a windowed sample cell which is then deposited into a chamber. Off-line, bench-top instruments need not meet any unusual operational/pressure/environmental/size/weight/space/safety constraints, but merely need to provide the requisite measurement precision for a manually-placed sample. Moreover, off-line instruments can be easily maintained between measurements.

In contrast to off-line analysis, on-line analysis provides “real-time” monitoring of sample composition at various points in the manufacturing process. For example, all fuel products are subject to sulfur level compliance—requiring some variant of on-line monitoring during fuel refining and transportation in pipelines. On-line analysis of fuels in a refinery and in pipelines, however, requires consideration of numerous operational issues not generally present in an off-line, laboratory setting.

For typical homogeneous samples (e.g., fluids generally, including finished petroleum product such as gasoline or diesel) in off-line analyzers (e.g., bench-top configurations) a safe assumption is that the analyte exists at a constant concentration throughout the volume of a sample cell, so an x-ray focal spot will produce the same measurement result throughout the volume. However, sample settling can occur for non-homogeneous samples in a sample cell. Portions of the sample (e.g., particulate) can either settle to the bottom or move to the top based on density and gravity and other factors. This potential sample movement/non-homogeneity within a sample cell (especially an XRF sample cell of the type discussed herein) presents measurement challenges, because the concentration of analyte at any particular focal point within the cell may not provide consistent measurement results.

Granular-type samples (e.g., soil) present a similar problem, where the concentrations of an analyte may vary within the soil sample collected and deposited in a typical sample cell. The entire range of concentrations, as well as average concentrations, across a typical sample may be required by local regulatory authorities.

What is required, therefore, are sample scanning techniques for analysis systems handling non-homogeneous samples, which provide analyte measurement results for localized areas of the sample, as well as a measurement representative of the overall concentration of the analyte in a sample volume, despite the presence of localized inconsistencies in the sample.

### SUMMARY OF THE INVENTION

The shortcomings of the prior art are overcome and additional advantages are provided by the present invention which in one aspect is a sample scanning apparatus/technique/method for a material analyzer. In one aspect, the present invention comprises moving a sample cell containing a sample over a measurement focal area of the analyzer according to a scan pattern, thereby scanning the sample over the measurement focal area in the scan pattern across the sample, thereby exposing multiple areas of the sample in the sample cell to the measurement focal area.

In one aspect of the present invention, a sample scanning apparatus for a material analyzer is disclosed, including a sample cell rotator for rotating a sample cell containing a sample over a measurement focal area of the analyzer; and a linear motion stage for linearly moving the rotating rotator and sample cell over the measurement focal area. The combined rotation and linear movement of the sample cell over the measurement focal area of the analyzer results in scanning the sample over the measurement focal area in a scan pattern across the sample, thereby exposing multiple areas of the sample in the sample cell to the measurement focal area.

In one embodiment, the sample cell being is removable and has an end with a film against which the sample is placed during measurement. The scan pattern can be a spiral can pattern produced by controllably moving the rotator and linear motion stage.

The sample scanning apparatus may be used in combination with an x-ray analyzer, the x-ray analyzer including an x-ray engine with an x-ray excitation path and an x-ray detection path, wherein the x-ray excitation and/or the x-ray detection path defines the sample focal area.

The focal area may be a focal point, defined by focused x-rays to/from at least one focusing optic in the x-ray excitation path and/or the x-ray detection path. The focusing optic may be a curved diffracting optic or a polycapillary optic.

The system may comprise a monochromatic wavelength-enabled XRF analyzer; e.g., an MWDXRF or ME-EDXRF analyzer.

The sample may comprise a liquid, partial-liquid, granular mixed liquid/solid material (e.g., soil), or a solid (e.g., powder) sample requiring the measurement of an analyte therein, such as S, Cl, P, K, Ca, V, Mn, Fe, Co, Ni, Cu, Zn, Hg, As, Pb, Cr, and Se.

The present invention is especially useful for measuring non-homogeneous samples, i.e., the present invention provides analyte measurement results for localized areas of the sample, as well as a measurement representative of the overall concentration of the analyte in a sample volume, despite the presence of localized inconsistencies in the sample.

Further, additional features and advantages are realized by the techniques of the present invention. Other embodiments and aspects of the invention are described in detail herein and are considered a part of the claimed invention.

### BRIEF DESCRIPTION OF THE DRAWINGS

The subject matter regarded as the invention is particularly pointed out and distinctly claimed in the claims at the conclusion of the specification. The foregoing and other objects, features, and advantages of the invention are apparent from the following detailed description taken in combination with the accompanying drawings in which:

FIG. 1 is a functional block diagram of the elements of an exemplary x-ray fluorescence system;

FIG. 2 is a schematic view of an exemplary MWD XRF x-ray engine useable with the sample scanning apparatus of the present invention.

FIG. 3 is a schematic view of an exemplary ME EDXRF x-ray engine useable with the sample scanning apparatus of the present invention;

FIG. 4 is a perspective view of a sample scanning apparatus in accordance with one aspect of the present invention;

FIG. 5 is a front plan view of the sample scanning apparatus of FIG. 4;

FIG. 6 is a perspective view of an exemplary sample cell useable with the present invention; and

FIG. 7 shows an exemplary sample scan pattern on the lower end of sample cell, in accordance with the present invention.

### DETAILED DESCRIPTION OF THE INVENTION

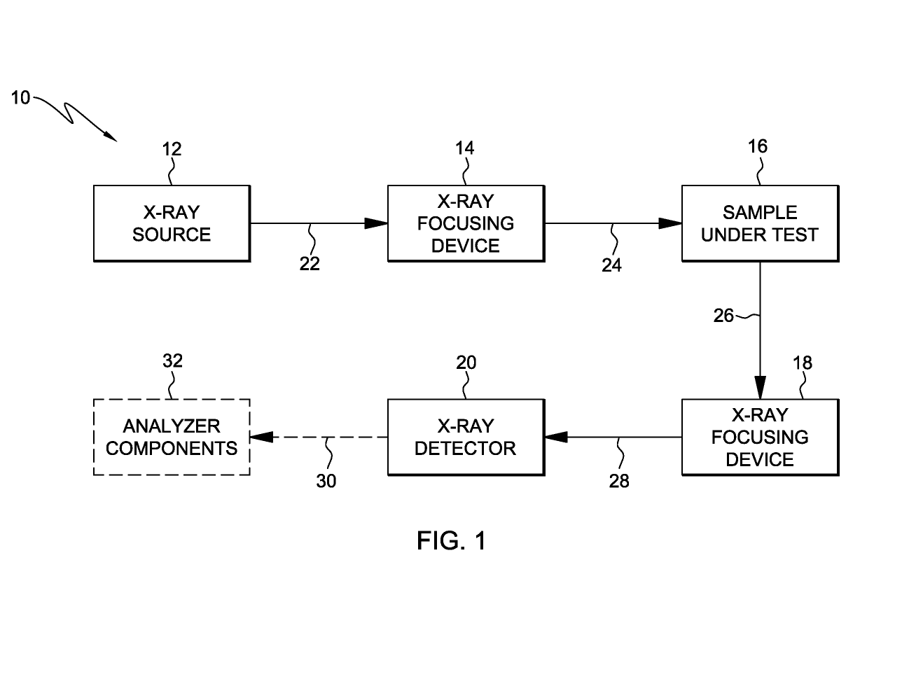

FIG. 1 is a functional block diagram of an exemplary XRF system 10 used for exposing a sample to x-ray radiation to produce fluorescent radiation which can then be detected and analyzed to determine a characteristic of the sample. The system may include an x-ray source 12, a first x-ray focusing device 14, a sample under test 16, a second x-ray focusing device 18, an x-ray detector 20, and analyzer components 32 for providing the analytical result. The x-ray source 12, for example, an x-ray tube, produces a beam of x-rays 22. Beam 22 may diffracted or focused by one or more x-ray focusing optics 14 as discussed further below.

When irradiated by beam 24, at least one of the constituents of sample in chamber 16 is excited in such a fashion that the constituent fluoresces, that is, produces a secondary source of x-rays 26 due to excitation by x-rays 24. Again, since x-ray beam 26 is typically a diverging beam of x-rays, beam 26 may be focused by the second x-ray focusing optics 18, for example, to produce a focused beam of x-rays 28 directed toward x-ray detector 20.

X-ray detector 20 may be a proportional counter- type or a semiconductor type x-ray detector (e.g., silicon drift detector), or any other suitable type of x-ray fluorescence detector known to one skilled in the art. Typically, x-ray detector 20 produces an electrical signal 30 containing a characteristic of the detected x-rays which is forwarded to analyzer components 32 for analysis, printout, or other display.

X-ray focusing devices/optics 14, 18 for advanced XRF systems, including those below, may include, for example, curved crystal monochromating optics such as those disclosed in commonly assigned U.S. Pat. Nos. 6,285,506; 6,317,483; 7,035,374 and 7,738,629; and/or polycapillary optics such as those disclosed in commonly assigned U.S. Pat. Nos. 5,192,869; 5,175,755; 5,497,008; 5,745,547; 5,570,408; and 5,604,353. Optic/source combinations such as those disclosed in commonly assigned U.S. Pat. Nos. 7,110,506; 7,209,545; and 7,257,193 are also useable. Each of the above-noted patents is hereby incorporated herein by reference in its entirety.

The following are two examples of x-ray-optic-enabled analyzer engines which may be used in connection with the present invention:

### Exemplary MWD XRF X-Ray Analysis Engines:

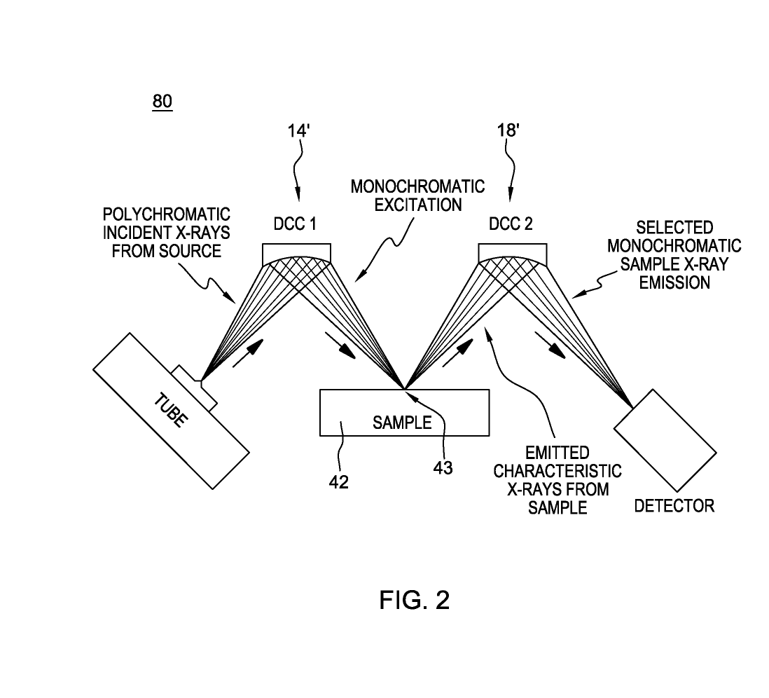

The assignee of the present invention has previously disclosed a Monochromatic Wavelength Dispersive X-ray Fluorescence (MWD XRF) analyzer 80 using two monochromating optic sets (U.S. Pat. Nos. 6,934,359 and 7,072,439—hereby incorporated by reference herein in their entirety), as shown schematically in FIG. 2. The related SINDIE (Sulfur IN DIEsel) and CLORA (chlorine) product lines for the measurement of e.g., sulfur and chlorine in diesel fuel and other petroleum products revolutionized XRF and provide many advantages including: (1) signal/background (S/B) is improved due to monochromatic excitation of the sample by DCC1 14′, i.e., the bremsstrahlung photons with energies under fluorescence peaks (which normally swamp these peaks of interest) can only reach the detector through scattering, therefore improving the SB ratio dramatically compared to polychromatic excitation; (2) superior energy resolution—this eliminates all common interference problems and provides the physical basis for upstream applications; (3) inherent robustness and low maintenance—the analysis engine is low power, compact, with no moving parts or consumable gasses; and (4) unprecedented dynamic range, e.g., a quantification level from 0.3 ppm to 5% of sulfur in a sample.

The MWD XRF engine 80, shown schematically in FIG. 2, includes curved monochromating optics 14′ and 18′ in the excitation and detection paths respectively, forming focal area or point 43 on the sample 42 (discussed further below), which is the configuration of the SINDIE sulfur analyzer discussed above. However, an optic may only be present in one of these paths, which still requires precise alignment. In one example, an optic of any of the above-describe types may only be present in the excitation path, and the detection path would include an energy dispersive detector. This is the common configuration of an energy dispersive x-ray fluorescence (EDXRF) system, discussed further below.

### Exemplary ME EDXRF X-Ray Analysis Engine:

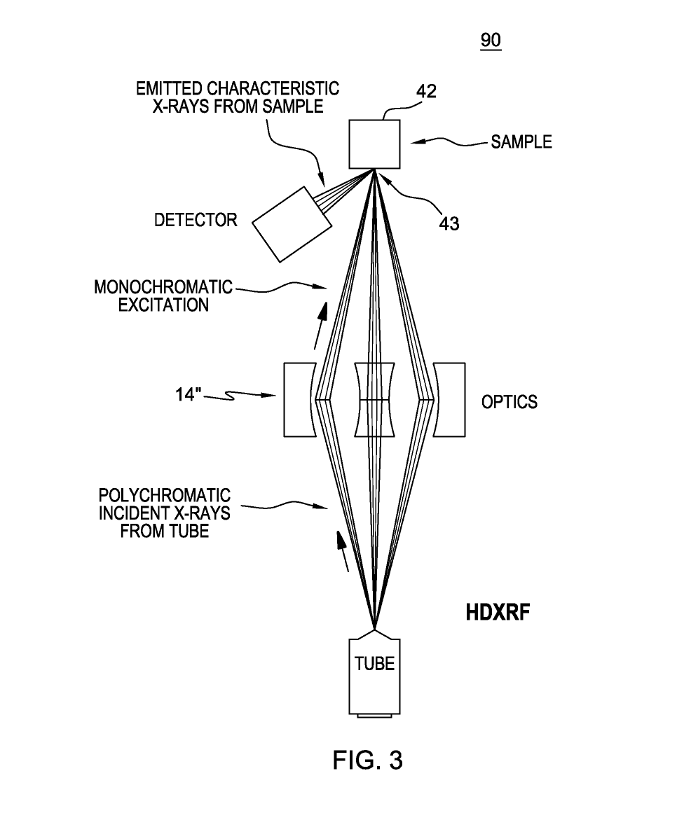

Monochromatic excitation, energy dispersive x-ray fluorescence (ME-EDXRF) analyzers can also be used for this application, in accordance with the present invention. The engine technology is disclosed in, e.g., commonly assigned U.S. Pat. No. 8,559,597 entitled XRF System Having Multiple Excitation Energy Bands In Highly Aligned Package, the entirety of which is hereby incorporated by reference herein. In one embodiment this engine 90 involves monochromatic excitation known as HD XRF as depicted schematically in FIG. 3. HD XRF is a multi-element analysis technique offering significantly enhanced detection performance over traditional ED or WD XRF. This technique applies state-of-the-art monochromating and focusing optics 14″ illuminating a focal area or point 43 on the sample 42, enabling multiple select-energy excitation beams that efficiently excite a broad range of target elements in the sample. Monochromatic excitation dramatically reduces scattering background under the fluorescence peaks, greatly enhancing elemental detection limits and precision.

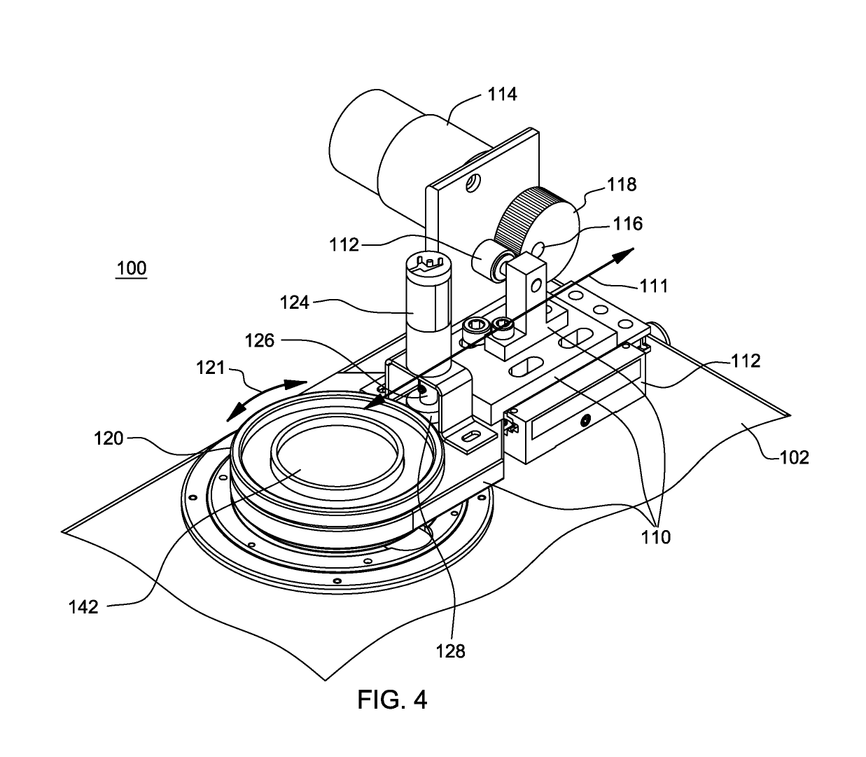

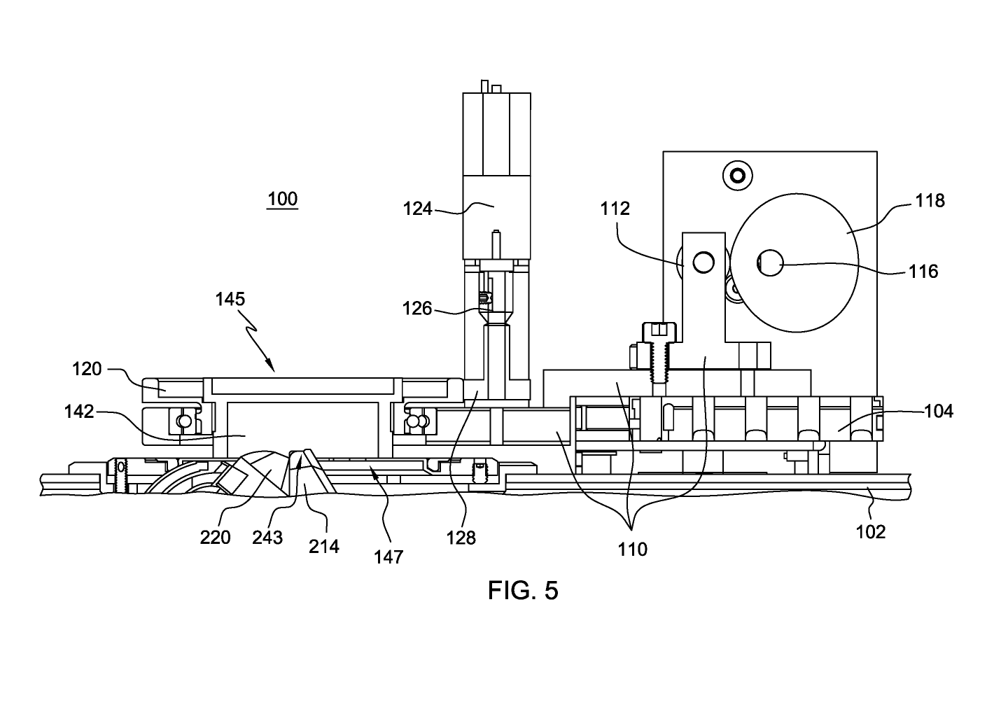

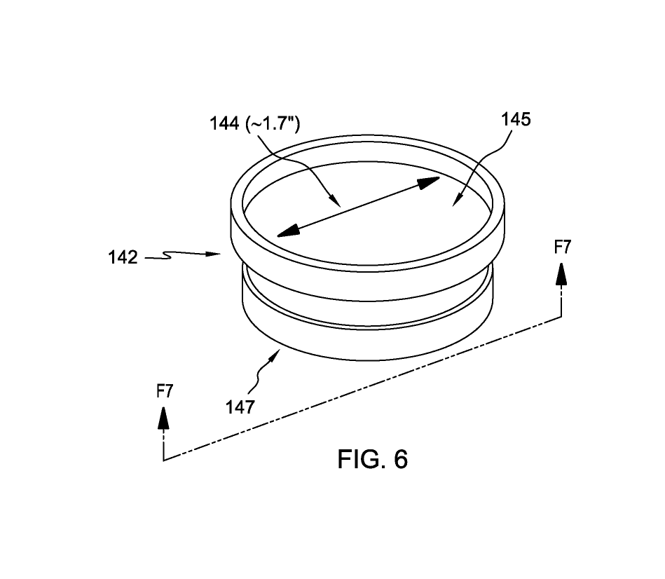

FIG. 4 is a perspective view, and FIG. 5 is a front plan view, of a sample scanning apparatus 100 in accordance with the present invention (where like reference numerals are used for like elements), used in combination with an exemplary sample cell of FIG. 6.

Summarizing with reference to FIGS. 4-6, sample cell 142 may be disposed in a sample cup rotator 120 mounted to a sample cell carriage 110. Cell 142/rotator 120 are together rotated along a rotation path 121, simultaneously with a lateral movement of the entire carriage 110 along a reciprocating lateral path 111, thereby scanning the sample past a focal area 243 (FIG. 5) of an x-ray engine (not entirely shown). The path types (rotational and linear) are exemplary only—any path type can be used in accordance with the principles of the present invention.

Sample cell may be a pre-filmed, precision sample cell 142, including an outer body forming an interior sample reservoir, the top end 145 of which accepts a sample, and the lower end of which 147 may be pre-filmed, for transmitting therethrough, input 214 and output 220 x-ray beams when placed in an analyzer. As discussed above, sample focal area or point 243 can be formed by these beams. The lower end 147 of the sample cell may be formed of a film (e.g., mylar) which can be wrapped tightly around the lower end of the body, and held in place using known techniques. The film is preferably designed with enough strength to hold the sample, while allowing penetration of x-rays, and resultant x-ray fluorescence from/to the x-ray analysis engine. In one embodiment, the sample cup may be a Chemplex sample cup having the approximate dimension 144 shown in FIG. 6; or alternatively an XOS Accu-Cell, as disclosed in commonly-assigned U.S. Pat. No. 7,729,471, the entirety of which is hereby incorporated by reference. Exemplary sample types include liquids, partial-liquids, granular mixed liquid/solid material (e.g., soil), or a solid (e.g., powder) sample.

The reciprocating lateral path 111 is effected, e.g., using motor 114 rigidly mounted to base apparatus base 102. Motor 114 may include a central shaft 116 which drives a cam 118 against a cam follower 112 rigidly mounted to the carriage 110, thereby moving the carriage linearly back and forth along path 111. The carriage 110 may be mounted in a linear motion stage 104 to ensure a true linear motion along path 111.

The simultaneous rotation path 121 is effected, e.g., using motor 124, rigidly mounted to carriage 110, having a central shaft 126 which drives a friction driving wheel 128 against an outer surface of the sample cup rotator 120, thereby rotating sample cell 120 relative to focal area 243 of the x-ray engine.

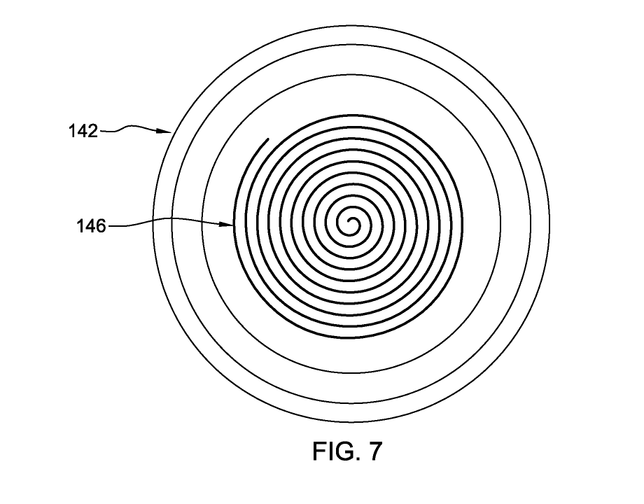

FIG. 7 shows an exemplary, spiral sample scan pattern 146 over the lower end of sample cell, in accordance with the present invention. This pattern results from the simultaneous rotational and lateral paths discussed above, over which the lower end of the sample cell travels, relative to the focal area of the x-ray engine. This spiral pattern allows much of the sample cell surface area (and therefore corresponding portions of a non-homogeneous sample) to fall within the focal area 243 of the engine, thereby providing continuous and/or discrete measurement possibilities along this pattern. This provides analyte measurement results for localized areas of the sample, as well as a measurement representative of the overall concentration of the analyte in a sample volume, despite the presence of localized inconsistencies in the sample.

Motors 114 and 124 may programmably operate at desired velocities over a desired measurement times, depending on operator and/or pre-programmed preferences, to effect any type of scan pattern, and measurement frequencies. Continuous and/or discrete measurements can take place over the pattern, and all results can be separately presented to an operator, or any type(s) of aggregates or averages thereof. This programming can be controlled together with, or separate from, other programming within analyzer.

Exemplary analytes measured in accordance with the present invention include: S, Cl, P, K, Ca, V, Mn, Fe, Co, Ni, Cu, Zn, Hg, As, Pb, Cr, and/or Se. Elements of particular interest for measurement in soil include: Hg, Pb, Cd, As, Ni, Mn, Cr, and Cu.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A sample scanning apparatus for a material analyzer, comprising:
a sample cell rotator for rotating a sample cell containing a sample over a measurement focal area of the analyzer; and
a linear motion stage for linearly moving the rotating rotator and sample cell over the measurement focal area;
wherein the combined rotation and linear movement of the sample cell over the measurement focal area of the analyzer results in scanning the sample over the measurement focal area in a scan pattern across the sample, thereby exposing multiple areas of the sample in the sample cell to the measurement focal area.

2. The apparatus of claim 1, further comprising the sample cell, the sample cell being removable and having an end with a film against which the sample is placed during measurement.

3. The apparatus of claim 1, wherein the scan pattern is a spiral can pattern produced by controllably moving the rotator and linear motion stage.

4. The apparatus of claim 1, in combination with an x-ray analyzer, the x-ray analyzer comprising an x-ray engine including:
an x-ray excitation path; and
an x-ray detection path;
wherein the x-ray excitation and/or the x-ray detection path defines the measurement focal area.

5. The combination of claim 4, wherein the focal area is a focal point.

6. The combination of claim 5, wherein the focal point is defined by focused x-rays to/from at least one focusing optic in the x-ray excitation path and/or the x-ray detection path.

7. The combination of claim 6, wherein the at least one focusing optic is at least one curved diffracting optic or polycapillary optic.

8. The combination of claim 6, wherein the at least one focusing optic is at least one focusing monochromatic optic.

9. The combination of claim 8, wherein the at least one focusing monochromatic optic is a curved crystal optic or curved multi-layer optic.

10. The combination of claim 5, wherein at least one focusing optic in the x-ray detection path is positioned such that an input focal point thereof is at the x-ray focal point, and corresponds to an output focal point of at least one focusing optic in the x-ray excitation path.

11. The combination of claim 4, wherein the x-ray analysis system comprises a monochromatic wavelength-enabled XRF analyzer.

12. The combination of claim 11, wherein the analyzer is an MWDXRF or ME-EDXRF analyzer.

14. The apparatus of claim 1, wherein the sample comprises a liquid, partial-liquid, granular mixed liquid/solid material (e.g., soil), or a solid (e.g., powder) sample requiring the measurement of an analyte therein.

15. The apparatus of claim 1, wherein an analyte measured is at least one element chosen from the following list: S, Cl, P, K, Ca, V, Mn, Fe, Co, Ni, Cu, Zn, Hg, As, Pb, Cr, and Se.

16. The apparatus of claim 1, wherein the sample is a non-homogeneous sample.

17. A sample scanning method in a material analyzer, comprising:
rotating a sample cell containing a sample over a measurement focal area of the analyzer; and
linearly moving the rotating rotator and sample cell over the measurement focal area;
wherein the combined rotation and linear movement of the sample cell over the measurement focal area of the analyzer results in scanning the sample over the measurement focal area in a scan pattern across the sample, thereby exposing multiple areas of the sample in the sample cell to the focal area.

18. The method of claim 17, further comprising the sample cell, the sample cell being removable and having an end with a film against which the sample is placed during measurement.

19. The apparatus of claim 17, wherein the scan pattern is a spiral scan pattern produced by controllably moving the rotator and linear motion stage.

20. A sample scanning method in a material analyzer, comprising:
moving a sample cell containing a sample over a measurement focal area of the analyzer according to a scan pattern, thereby scanning the sample over the measurement focal area in the scan pattern across the sample, and exposing multiple areas of the sample in the sample cell to the measurement focal area.
